(19) United States
(12) Patent Application Publication
(10) Pub. No.: US 2024/0183823 A1
(43) Pub. Date: Jun. 6, 2024

(54) METHOD AND SYSTEM OF MOISTURE CONTENT DETECTION

(71) Applicant: TRIAD National Security, LLC., Los Alamos, NM (US)

(72) Inventors: Troy Allen Semelsberger, Los Alamos, NM (US); Cristian Pantea, Los Alamos, NM (US); John James Greenhall, Los Alamos, NM (US)

(21) Appl. No.: 18/571,654

(22) PCT Filed: Jun. 24, 2022
(86) PCT No.: PCT/US2022/034900

§ 371 Date: Dec. 18, 2023

Related U.S. Application Data
(60) Provisional application No. 63/214,663, filed on Jun. 24, 2021.

(51) Int. Cl. G01N 29/04; G01N 29/30; G01N 29/38; G01N 29/44

(52) U.S. Cl. CPC G01N 29/043; G01N 29/30; G01N 29/38; G01N 29/4454; G01N 2291/02845; G01N 2291/102

(57) ABSTRACT

A system includes an acoustic transmitter, an acoustic receiver, a memory component, and a processor. The acoustic transmitter transmits an acoustic signal into a material with an unknown moisture level and changes into an acoustic response signal after passing through the material. The acoustic receiver receives the acoustic response signal associated with the material with the unknown moisture level. The memory component stores data comprising moisture levels associated with acoustic speeds of acoustic response signals. The processor is coupled to the acoustic receiver and to the memory and determines a speed of the acoustic response signal associated with the material with the unknown moisture level, and further determines an actual moisture level of the unknown moisture level of the material by associating the speed of the acoustic response signal associated with the material with the unknown moisture level to the data in the memory component.

### RELATED APPLICATIONS

This is a US National Stage Application that claims the benefit and priority to the PCT Application number PCT/US22/34900, which was filed on Jun. 24, 2022 and claims the benefit and priority to the Provisional Application No. 63/214,663, which was filed on Jun. 24, 2021, and both of which are incorporated herein by reference in their entirety.

### FEDERALLY SPONSORED RESEARCH OR DEVELOPMENT

The United States government has rights in this invention pursuant to Contract Number 89233218CNA000001 Between the U.S. Department of Energy and Triad National Security, LLC for operation of Los Alamos National Laboratory. The government has certain rights in the invention.

### BACKGROUND

Moisture may affect various aspects of a product, e.g., weight, volume, etc. Moreover, moisture in certain products should be adequately controlled, e.g., pharmaceutical industry, to maintain the efficacy of the product. As another example, biomass such as corn stover that is used to generate bioenergy such as ethanol and butanol is first transported before processing. The amount of moisture in corn stover may impact the cost of transportation, e.g., dryer corn stover is lighter and costs less to transport in comparison to corn stover with higher moisture content.

High processing costs as well as transportation costs, e.g., in the energy industry and specifically bioenergy, may present obstacles in full scale biomass conversion. The transportation cost is exacerbated by variability of moisture content, e.g., extrinsic moisture resulting from different harvest/weather conditions, in biomass such as corn stover. The processing cost in generating bioenergy from biomass such as corn stover is also affected by the variation in moisture content because the processing involves various chemical reactions where moisture content is presumed to be a constant value, e.g., dilute-acid pretreatment and enzymatic hydrolysis presumes a 20% moisture and any deviation from this significantly affects the resulting pH and reduced yield.

Regardless of the application, many industries need to measure the amount of moisture in their product. For example, measuring moisture in corn stover is an important aspect of achieving and maintaining uniform moisture content.

One conventional method to measure moisture of a corn stover has been to use electrical probes on sides of the corn stover bale to measure electrical conductivity of a bale, which results in measuring moisture content of the surface only which can be very different from internal moisture content of the bale. Another conventional system may utilize near-infrared reflectance spectroscopy to measure near-infrared absorption of light by water molecules on the bale, which also provides moisture measurement on the surface of the bale that can vary greatly in comparison to the internal moisture content of the bale. In another conventional system, microwave transmission geometry may be used to measure moisture content up to 25% moisture content, which is inadequate and inaccurate for higher moisture content.

### SUMMARY

Accordingly, a need has arisen to measure moisture content accurately and reliably to higher moisture content, e.g., 15% to 55%. The embodiments utilize acoustic wave to propagate through material, e.g., corn stover, without being absorbed by water molecules. In some embodiments, an acoustic actuator (transmitter) may generate acoustic signal that is transmitted through content, e.g., corn stover. The response of the transmitted acoustic signal is received by a receiver, e.g., acoustic receiver. The speed of transmission can be measured and compared to one or more calibrated models, e.g., calibrated model for 15% moisture, calibrated model for 20%, etc., in order to determine the moisture content. In some embodiments, the calibrated models are generated by measuring the speed of acoustic signal at different moisture contents and yet in other embodiments machine learning may be leveraged to generate one or more models.

In some embodiments, a system includes an acoustic transmitter configured to transmit an acoustic signal into a material with an unknown moisture level, wherein the acoustic signal associated with the material with the unknown moisture level changes into an acoustic response signal after passing through the material. The system includes an acoustic receiver configured to receive the acoustic response signal associated with the material with the unknown moisture level. The system includes a memory component configured to store data, e.g., a calibrated model, wherein the data comprises a plurality of moisture levels associated with a plurality of acoustic speeds of a plurality of acoustic response signals. The system also includes a processor coupled to the acoustic receiver and to the memory, wherein the processor is configured to determine a speed of the acoustic response signal associated with the material with the unknown moisture level, and further configured to determine an actual moisture level of the unknown moisture level of the material by associating the speed of the acoustic response signal associated with the material with the unknown moisture level to the data in the memory component.

In some embodiments, the system further includes an amplifier coupled to the acoustic transmitter, wherein the amplifier is configured to amplify the acoustic signal associated with the material with the unknown moisture level. In some embodiments, the system further includes a preamplifier coupled to the acoustic receiver, wherein the preamplifier is configured to amplify the acoustic response signal.

According to some embodiments, the calibrated model may be generated based on a distance between the acoustic transmitter and the acoustic receiver, a packing density of the material, and the plurality of acoustic signal speeds through the material at known moisture levels.

In one nonlimiting example, the acoustic transmitter faces the acoustic receiver. In one nonlimiting example, the acoustic signal is a Tukey window sinusoidal burst signal.

In some embodiments a system includes an acoustic transmitter configured to transmit an acoustic signal into a material with an unknown moisture level, wherein the acoustic signal associated with the material with the unknown moisture level changes into an acoustic response signal after passing through the material. The system includes an acoustic receiver configured to receive the acoustic response signal associated with the material with the unknown moisture level. The system may also include a memory component configured to store data, e.g., calibrated model, wherein the data comprises a plurality of moisture levels associated with a plurality of acoustic amplitudes of a plurality of acoustic response signals. The system includes a processor coupled to the acoustic receiver and to the memory, wherein the processor is configured to determine an amplitude of the acoustic response signal associated with the material with the unknown moisture level, and further configured to determine an actual moisture level of the unknown moisture level of the material by associating the amplitude of the acoustic response signal associated with the material with the unknown moisture level to the data in the memory component.

In some embodiments, the system further includes an amplifier coupled to the acoustic transmitter, wherein the amplifier is configured to amplify the acoustic signal associated with the material with the unknown moisture level. In some embodiments, the system further includes a preamplifier coupled to the acoustic receiver, wherein the preamplifier is configured to amplify the acoustic response signal.

According to some embodiments, the calibrated model may be generated based on a distance between the acoustic transmitter and the acoustic receiver, a packing density of the material, and the plurality of acoustic amplitudes through the material at known moisture levels.

In one nonlimiting example, the acoustic transmitter faces the acoustic receiver. In one nonlimiting example, the acoustic signal is a Tukey window sinusoidal burst signal.

In some embodiments, a method includes transmitting an acoustic signal, e.g., a Tukey window sinusoidal burst signal, into a material with an unknown moisture level, wherein the acoustic signal associated with the material with the unknown moisture level changes into an acoustic response signal after passing through the material. The method also includes receiving the acoustic response signal associated with the material with the unknown moisture level. The method also includes processing the acoustic response signal to determine a speed of the acoustic response signal. In some embodiments the method includes determining a moisture level of the material by associating the speed of the acoustic response signal to a data, wherein the data comprises a plurality of moisture levels associated with a plurality of acoustic speeds of a plurality of acoustic response signals.

It is appreciated that the method may further include amplifying the acoustic signal associated with the material with the unknown moisture level. In some embodiments, the method may further include amplifying the acoustic response signal.

It is appreciated that the data may be a calibrated model that is generated based on a distance between an acoustic transmitter and an acoustic receiver, a packing density of the material, the plurality of acoustic signal speeds through the material at known moisture levels.

The method may further include transporting the material and positioning the material between an acoustic transmitter and an acoustic receiver.

In some embodiments, a method includes transmitting an acoustic signal into a material with an unknown moisture level, wherein the acoustic signal, e.g., a Tukey window sinusoidal burst signal, associated with the material with the unknown moisture level changes into an acoustic response signal after passing through the material. The method also includes receiving the acoustic response signal associated with the material with the unknown moisture level. In some embodiments, the method includes processing the acoustic response signal to determine an amplitude of the acoustic response signal. The method also includes determining a moisture level of the material by associating the amplitude of the acoustic response signal to a data, wherein the data comprises a plurality of moisture levels associated with a plurality of acoustic amplitudes of a plurality of acoustic response signals.

It is appreciated that the method may further include amplifying the acoustic signal associated with the material with the unknown moisture level. In some embodiments, the method may further include amplifying the acoustic response signal.

It is appreciated that the data may be a calibrated model that is generated based on a distance between an acoustic transmitter and an acoustic receiver, a packing density of the material, the plurality of acoustic signal amplitudes through the material at known moisture levels.

The method may further include transporting the material and positioning the material between an acoustic transmitter and an acoustic receiver.

In some embodiments, a method includes transmitting a plurality of acoustic signals into a material at a plurality of known moisture levels, wherein an acoustic signal changes into an acoustic response signal after passing through the material. The method also includes processing a plurality of acoustic response signals resulting from the plurality of acoustic signals to determine a speed or amplitude associated with the plurality of acoustic response signals. The method includes generating a data to correlate the plurality of known moisture levels to a plurality of speeds or a plurality of amplitudes. In some embodiments, the method further includes controlling the plurality of moisture levels using an air flow controller.

These and other features and aspects of the concepts described herein may be better understood with reference to the following drawings, description, and appended claims.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts a nonlimiting example of a system to generate a calibrated model for a given moisture content.

FIG. 2A depicts a nonlimiting example of generated acoustic signal and its response in accordance with some embodiments.

FIG. 2B depicts a nonlimiting example of signal amplitude and speed change at different moisture content in accordance with some embodiments.

FIG. 3 depicts a system for measuring moisture content in accordance with some embodiments.

FIG. 4 is a relational node diagram depicting an example of a neural network for determining moisture content in accordance with some embodiments.

FIG. 5A shows a nonlimiting example of a flow diagram associated with generating a calibrated model to be used in determining moisture content level in accordance with some embodiments.

FIG. 5B shows a nonlimiting example of a flow diagram associated with determining a moisture level content based on the calibrated model in accordance with some embodiments.

FIG. 6 shows a block diagram depicting an example of computer system suitable for measuring/processing moisture content in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

The embodiments described here measure moisture content, regardless of the application, e.g., pharmaceutical, bioenergy, food industry, mining industry, additive manufacturing, coatings, etc. It is appreciated that the embodiments are described with respect to measuring moisture content for corn stover is for illustrative purposes and should not be construed as limiting the scope of the embodiments.

Biomass is increasingly being used in energy applications in the U.S. There are four categories of biomass produced from plants and animals: alcohol fuel, landfill gas, solid waste, and wood and agricultural products. Among those, wood and agricultural products is the largest category, making up more than 80% of the total biomass in the U.S. with minimal food value to humans and livestock, but which can be utilized as bioenergy feedstocks. Biomass is converted to liquid fuel, such as ethanol and butanol, through combinations of processes such as microbial activity, thermal processing, and addition of chemical reagents. Bioenergy feedstocks are primarily derived from three types of biomass materials: lipids, sugars or starches, and cellulose or lignocellulose. With a short life cycle of less than three months, the cellulose/lignocellulose group holds the least amount of capital worth due to its minimal food value to humans. Among all available cellulosic/lignocellulosic feedstocks, crop residues are the least expensive materials with little-to-no impacts on food security. The most abundant crop in the United States, Mexico, and most of Europe is corn, and the crop residue is known as corn stover.

The abundant quantity and low cost of corn stover indicates that corn stover has the potential to become the largest and most profitable annual crop-based bioenergy commodity, which would be critical to satiating the global demand for liquid fuel and poses a possible solution the U.S. Department of Energy's mission to solve current and future energy challenges. As discussed above, high processing costs as well as transportation costs may present obstacles in full scale biomass conversion. Moreover, as discussed above, the variability of corn stover moisture content has been a common problem that financially affects every aspect of biofuel conversion from harvest to handling and processing.

Moisture may be intrinsic or extrinsic where the intrinsic value contains the moisture without any weather condition and may be realized under laboratory conditions. Alternatively, the extrinsic moisture content may be found in harvested corn stover and may depend on various factors such as the weather conditions, thereby unpredictable and uncontrollable. As described above, extrinsic moisture content, e.g., as measured by electrical probes, near-infrared reflectance spectroscopy, etc. and other technologies such as microwave have traditionally been used to measure moisture content, which have proven to be deficient.

As discussed above, the cost of transportation may increase due to moisture content, e.g., an increase in moisture content from 20% to 40% increases the total cost by 33%. Moreover, as presented above, the biochemical conversion of lignocellulosic biomass is also affected by the variation of moisture content of corn stover, e.g., resulting in a different pH level, different yield, etc.

Accordingly, there is a need to accurately and reliably measure moisture content in compounds, e.g., corn stover, compounds used in additive manufacturing, compounds used in pharmaceutical industry, etc., in order to achieve and maintain consistent moisture content. In comparison to traditional methods to measure moisture content, use of acoustic signal (wave) has proven to be more effective because acoustic signal propagates through most material without being absorbed by the water molecule.

In some embodiments, an acoustic signal is generated, e.g., using acoustic signal actuator. The generated acoustic signal is transmitted through the material where the moisture content is being measured. The speed of acoustic signal varies depending on different moisture content. An acoustic signal receiver may be used to receive the generated acoustic signal that is propagated through the material. In some embodiments, one or more calibrated models, for speed of propagation for acoustic signal, may be generated for a controlled sample, e.g., sample at 10% moisture content, sample at 15% moisture content, . . . , sample at 55% moisture content, etc. The calibrated model illustrates the change of speed for different moisture content. Once the one or more calibrated models are generated, one or more acoustic signals may be generated to measure moisture content of material, e.g., corn stover. The speed of the acoustic signal may be measured and compared to the one or more calibrated models. As such, the moisture content of the material may be reliably and accurately measured.

In some embodiments, instead of the speed of acoustic signal, the amplitude of the acoustic signal is measured that varies depending on different moisture content. An acoustic signal receiver may be used to receive the generated acoustic signal that is propagated through the material. In some embodiments, one or more calibrated models, for the amplitude of the acoustic signal, may be generated for a controlled sample, e.g., sample at 10% moisture content, sample at 15% moisture content, . . . , sample at 60% moisture content, etc. The calibrated model illustrates the change of amplitude for different moisture content. Once the one or more calibrated models are generated, one or more acoustic signals may be generated to measure moisture content of material, e.g., corn stover. The amplitude of the acoustic signal may be measured and compared to the one or more calibrated models. As such, the moisture content of the material may be reliably and accurately measured.

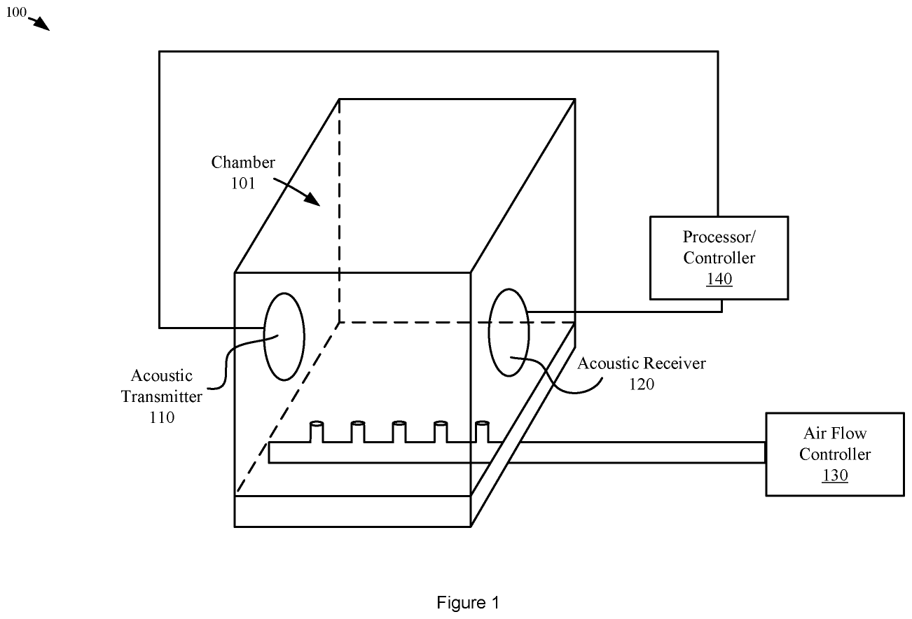

FIG. 1 depicts a nonlimiting example of a system to generate a calibrated model for a given moisture content. Embodiments herein present a sensing technique based on acoustic time-of-flight and/or amplitude measurement. By measuring the change in sound speed and/or signal amplitude, embodiments herein can accurately quantify the change in corn stover moisture content at packing densities, e.g., higher than the bale form 200 kg/m3. The sound speed and/or signal amplitude can be measured at various moisture content values to create one or more calibrated model where the calibrated model illustrates changes in acoustical properties at various moisture content of corn stover.

In some embodiments, the system 100 includes a chamber 101, an acoustic transmitter 110, an acoustic receiver 120, an air flow controller 130, and a processor/controller 140. It is appreciated that the air flow controller 130 is configured to control the amount of moisture content of corn stover placed within the chamber by increasing/decreasing air flow within the chamber 101. In some embodiments, the moisture content is controlled at various moisture content intervals, e.g., 10%, 15%, 20%, . . . , 60%, etc. It is appreciated that the moisture content may be controlled at any increments, e.g., 1%, 0.5%, 5%, etc., and the increments that are show are for illustrative purposes and should not be construed as limiting the scope of the embodiments. In some embodiments, the chamber 101 may include Styrofoam foam with hydrophobic inner walls. It is appreciated that the corn stover moisture content may be reduced using the air flow controller 130, e.g., constant flow of dry air from the bottom of the chamber 101 is controlled by a mass flow controller with a flow range of approximately 1500 sccm at 40 psi.

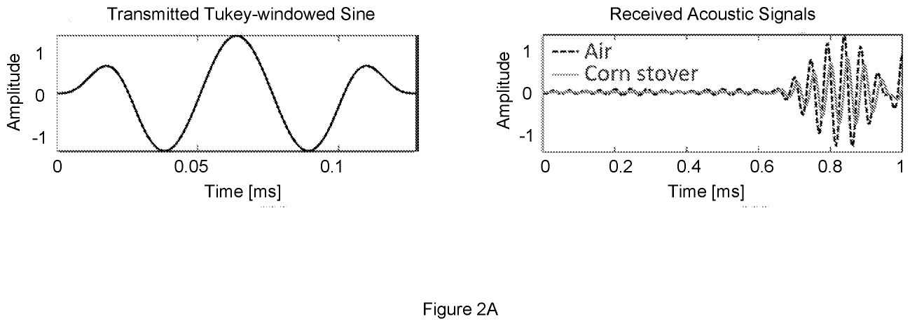

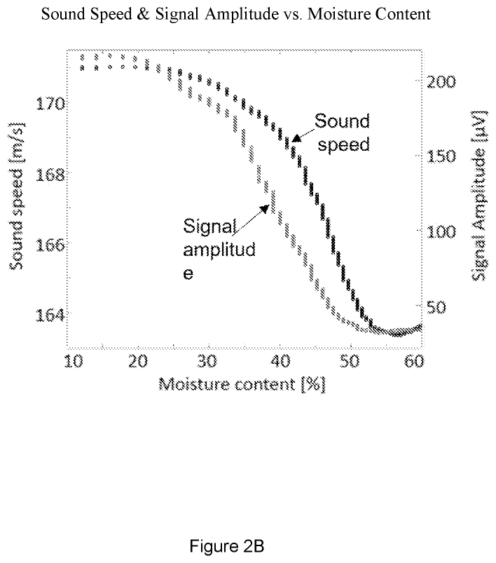

In one nonlimiting example, the acoustic transmitter 110 includes an acoustic actuator that generates and transmits an acoustic signal, e.g., Tukey envelope with α≥0.5 to remove any artifacts introduced by the transients at the rising and falling edges, Gaussian waveform, etc., ranging between 10 kHz to 80 kHz, as shown in FIG. 2A. It is appreciated that the Tukey signal may be a sinusoidal burst signal, Tukey-windowed sinusoidal signal, etc. In some embodiments, the Tukey signal may have a sinusoidal frequency of 19.6 kHz windowed by a Tukey window with cosine lobe width of 0.5. In some examples, the acoustic actuator may be separate from the transmitter and the integration of the actuator and the transmitter is for illustrative purposes and should not be construed as limiting the scope of the embodiments. The acoustic receiver 120 detects an acoustic response signal that is a response signal to the generated acoustic signal, e.g., FIG. 2A shows the response signal for air and also for corn stover. The acoustic transmitter 110 and the acoustic receiver 120 may be a pair of air-coupled acoustic transducers. The processor/controller 140 may be used to perform cross correlation and Fast Fourier Transform on the detected acoustic response signal and the generated acoustic signal in order calculate the speed of sound and amplitude of the sound signal from A-scan.

In one nonlimiting example, a one-cycle excitation pulse with a period of 125 us may be generated by the acoustic transmitter 110 as the acoustic signal to capture the entire transmitted waveform. A cross-correlation may be performed by the processor/controller 140 to calculate the sound speed of corn stover. The acoustic signal generated by the acoustic transmitter 110 through air is cross correlated with the acoustic signal through the dry corn stover to calculate the time delay between the two signals, Δt. Then, by determining the air's signal arrival time as a baseline t0, the arrival time t for the dry corn stover signal can be calculated by t=t0+Δt. The sound speed c is then calculated using the formula: c=(d)/(t), where d is the distance between the acoustic transmitter 110 and the acoustic receiver 120, which is 5 cm in this example.

Accordingly, the air flow controller 130 is used to control the moisture content of the corn stover within the chamber 101. At each desired moisture content, e.g., 10%, 11%, . . . , 55%, etc., an acoustic signal is generated and transmitted using the acoustic transmitter 110 and a response signal is detected using the acoustic receiver 120. The processor/controller 140 performs Fast Fourier Transform and cross correlation on the response signal and the generated acoustic signal in order to calculate the speed of sound and amplitude. The process may be performed at each desired moisture content in order to generate one or more calibrated model, as shown in FIG. 2B. The calibrated model may be stored within a memory component and be coupled to the processor/controller 140 for later use.

It is appreciated that while the speed of acoustic signal remains unchanged it has an inverse to the packing density of the material, e.g., corn stover. It is appreciated that the system, as described above, may be used to accurately sense the moisture content at a center of a packed sample of corn stover at a density above 300 kg/m3.

It is appreciated that the system is described with respect to determining moisture content of corn stover for illustrative purposes and should not be construed as limiting the scope of the embodiments. For example, a similar setup may be used for measuring moisture content of material used in pharmaceutical industry. The corn stover as described here is a porous lignocellulosic material, with a mean loose-filled bulk density and a mean tapped bulk density of ˜50 kg/m3 and ˜55 kg/m3 respectively. These low bulk densities are due to air-filled pockets in the corn stover structure. It is appreciated that the inner surface of corn stover is filled with air pores with diameters of 50-200 nm. Additionally, there are significant air gaps between corn stover sections, even in highly packed density configurations. As such, an acoustic wave propagates through an interface between two materials will be partially reflected and partially transmitted. The amount of energy that is reflected/transmitted depends on the difference in acoustic impedance between the two materials, where a high difference in the acoustic impedance between the two materials at the interface leads to less energy being transmitted and vice versa. The acoustic impedance is defined as Z=ρc for a material with density ρ and sound speed c. The large density differences between the air gaps and corn-stover causes the acoustic waves to be significantly reflected. Corn stover may also exhibit high acoustic absorption, which attenuates acoustic waves and inhibits propagation through the corn stover. This attenuation increases as moisture content increases.

In some embodiments, an amplifier may be used to mitigate acoustic attenuation in corn stover. For example, the acoustic signal that is generated by the acoustic transmitter 110 may be amplified with a 50 dB power amplification (˜316×) and the acoustic receiver 120 may be coupled to a preamplifier with 40 dB amplification to amplify the response signal. In one nonlimiting example, to mitigate high attenuation of corn stover, a high-power transducer with a resonance frequency of about 19.5 kHz, and a matching layer for transmission in air may be used.

It is appreciated that in some embodiments the acoustic transmitter 110 and the acoustic receiver 120 are positioned facing each other to maximize acoustic transmission for illustration purposes that should not be construed as limiting the scope of the embodiments. For example, in some embodiments, the acoustic transmitter 110 and the acoustic receiver 120 may be on the same side where the acoustic receiver 120 detects the reflected acoustic signal response. In one nonlimiting example, 50-Ohm shunt loads are connected in parallel with the acoustic transmitter 110 and with the acoustic receiver 120 to match the electrical impedances of the acoustic transmitter 110 to the power amplifier and the acoustic receiver 120 to the preamplifier.

It is appreciated that density of a medium, e.g., corn stover, may be a factor that affects the sound speed. The packing density of corn stover may vary from ˜55 kg/m3 (tapped bulk density) at the super sack storage to ˜50 kg/m3 (loose bulk density) at the conveyor belt. Measuring the speed of sound for each density, e.g., 50 and 55 kg/m3, at a separation distance of 5 cm and 10 cm between the acoustic transmitter 110 and the acoustic receiver 120 indicated a decrease in the speed of sound, e.g., a 5% increase in packing density results in a 21 m/s decrease in the speed of sound at both distances, as shown in Table 1 below. It is appreciated, that a similar process may be performed for other types of materials, as needed.

TABLE 1
Sound speed vs. packing density in dry corn
stover at two transducer separation

| | Packing Density | | |
|---|---|---|---|
| Transducer | 50 kg/m³ | 55 kg/m³ | Change in |
| Separation | Sound Speed | Sound Speed | Sound Speed |
| (cm) | (m/s) | (m/s) | (m/s) |
| 5 | 299 | 278 | 21 |
| 10 | 298 | 277 | 21 |

In other words, variation in the speed of sound results from a change in separation distance of the acoustic transmitter 110 and the acoustic receiver 120 and the arrival time measurements. It has been determined that for this nonlimiting example, the propagation error is less than 2 m/s. Moreover, the signal amplitude also slightly decreases with increased packing density. The inverse relation between sound speed and the packing density is also observed in other materials such as wood. A similar relationship (i.e., between the sound speed and the packing density) exists for porous media such as wheat grain, soybean, and biomass pellet. It is appreciated that the sound speed may be directly related to the diameter of the cylindrical air pocket between particles, i.e., packing density. Thus, the higher the packing density, the smaller the air gap between particles and the smaller the diameter of the cylindrical air-pocket, resulting in a lower sound speed.

As illustrated in FIG. 2B, a calibrated model can be generated using the system 100 of FIG. 1. FIG. 2B illustrates that as the moisture content increases from 20 to ˜55%, the sound speed decreases from 171 m/s to 163.5 m/s. Moreover, the peak amplitude of the Fast Fourier Transform decreases from 2.2×10-4 V-s to 0.3×10-4 V-s. The determined speed and/or amplitude may be compared against the calibrated model to determine the moisture content. The system, as described, results in accurate and improved measurement of moisture content, which results in reduced cost of processing and transportation in bioenergy industry.

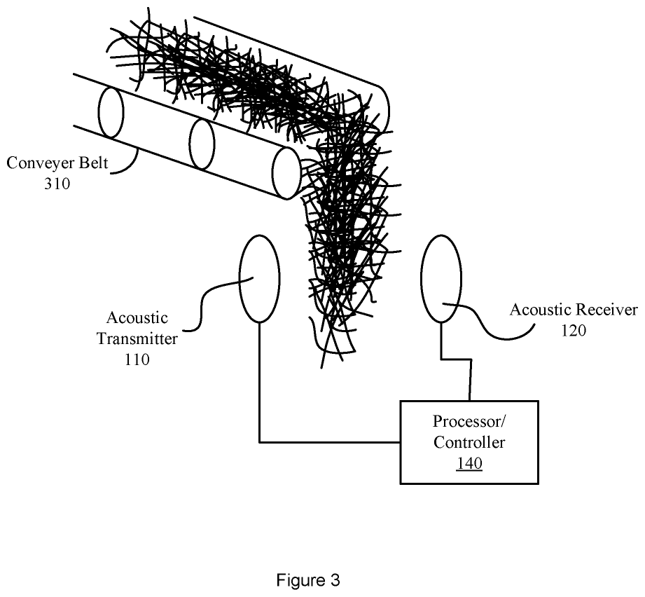

FIG. 3 depicts a system for measuring moisture content in accordance with some embodiments. FIG. 3 shows a system that is substantially similar to that described in FIGS. 1-2B. In this embodiment, the moisture content of the material is unknown and not controlled like that of FIG. 1. In this nonlimiting example, the material, e.g., corn stover, is being delivered over a conveyer belt 310. It is appreciated that any transport mechanism may be employed and that use of the conveyer belt 310 is for illustrative purposes. In this example, the corn stover is being delivered and as it is being dropped, an acoustic signal is generated by the acoustic transmitter 110 (as described above). The response to the generated acoustic signal is being detected by the acoustic receiver 120, as described above. As described above, the captured information, e.g., generated acoustic signal and/or a response to the generated acoustic signal, is transmitted to the processor/controller 140 for processing. The processor/controller 140 utilizes the received data and determines the speed and/or amplitude associated with the acoustic signal. The speed and/or amplitude of the acoustic signal (response) may be compared to the calibrated model that has been apriori generated (as described in FIGS. 1-2B). The comparison of the determined speed and/or amplitude to the calibrated model identifies the moisture content of the corn stover. Use of the conveyor belt 310 and the system as described enables inline sensing of moisture content accurately and reliably.

In other words, the calibrated model as generated and as described in FIGS. 1-2B can be used to match the determined acoustic speed and/or amplitude, as determined in FIG. 3, in order to determine the moisture content in corn stover.

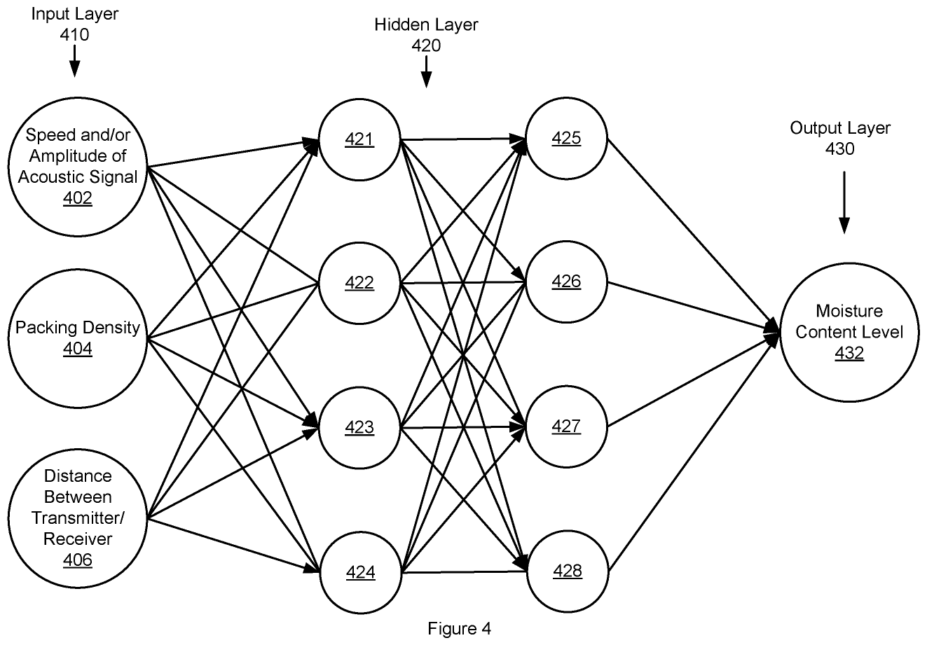

FIG. 4 is a relational node diagram depicting an example of a neural network for determining moisture content in accordance with some embodiments. In an example embodiment, the neural network 400 utilizes an input layer 410, one or more hidden layers 420, and an output layer 430 to train the machine learning algorithm(s) or model to determine the moisture content based on various factors, e.g., packing density, distance between the transmitter/receiver, detected speed of sound and/or amplitude of the acoustic signal, etc. In some embodiments, the speed and/or amplitude of acoustic signal 402 (that is measured as described above) and/or packing density 404 and/or distance between transmitter/receiver changes 406 are known and the moisture content level 432 is also known by being controlled, e.g., as described in FIG. 1. In some embodiments, supervised learning is used such that known input data, a weighted matrix, and known output data are used to gradually adjust the model to accurately compute the already known output. Once the model is trained (e.g., as described in FIGS. 1-2B), i.e., calibrated model is generated, field data is applied as input (e.g., as described in FIG. 3), e.g., measured speed and/or amplitude, packing density, distance between transmitter/receiver, etc., and a predicted output, e.g., moisture content level, is determined. In other embodiments, where the input data has not yet been confirmed, unstructured learning is used such that a model attempts to reconstruct known input data over time in order to learn. FIG. 4 is described as a structured learning model for depiction purposes and is not intended to be limiting.

Training of the neural network 400 using one or more training input matrices, a weight matrix, and one or more known outputs is initiated by one or more computers associated with the system of FIGS. 1-3. In an embodiment, a server may run known input data through a deep neural network in an attempt to compute a particular known output. For example, a server uses a first training input matrix and a default weight matrix to compute an output. If the output of the deep neural network does not match the corresponding known output of the first training input matrix, the server adjusts the weight matrix, such as by using stochastic gradient descent, to slowly adjust the weight matrix over time. The server computer then re-computes another output from the deep neural network with the input training matrix and the adjusted weight matrix. This process continues until the computer output matches the corresponding known output. The server computer then repeats this process for each training input dataset until a fully trained model is generated.

In the example of FIG. 4, the input layer 410 includes a measured speed and/or amplitude of acoustic signal 402 (as described in FIG. 1), packing density 404 (which may be known), and distance between transmitter/receiver 406 (which may be known), etc. It is appreciated that any type of input data can be used to train the model. The output may include the moisture content level 432 which may be known by being controlled, e.g., using the air flow controller.

In the embodiment of FIG. 4, hidden layers 420 represent various computational nodes 421, 422, 423, 424, 425, 426, 427, 428. The lines between each node 421, 422, 423, 424, 425, 426, 427, 428 represent weighted relationships based on the weight matrix. As discussed above, the weight of each line is adjusted overtime as the model is trained. While the embodiment of FIG. 4 features two hidden layers 420, the number of hidden layers is not intended to be limiting. For example, one hidden layer, three hidden layers, ten hidden layers, or any other number of hidden layers may be used for a standard or deep neural network. The example of FIG. 4 also features an output layer 430 with the moisture content level 432 as the known output (i.e., controlled as described above). As discussed above, in this structured model, the moisture content level 432 is used as a target output for continuously adjusting the weighted relationships of the model. When the model is successfully trained it may be used to process live or field data.

Once the neural network 400 of FIG. 4 is trained, the trained model will accept field data at the input layer 410, such as measured speed and/or amplitude of acoustic signal (as described above), packing density, distance between transmitter/receiver, etc. In some embodiments, the field data is live data that is accumulated in real time. In other embodiments, the field data may be current data that has been saved in an associated database. The trained model is applied to the field data in order to determine the moisture content level 432 at the output layer 430.

It is appreciated that neural network has been described for illustrative purposes and it should not be construed as limiting the scope of the embodiments. For example, other machine learning methodologies such as decision tree, random forest model, adaptive boost model, support vector machine, k-nearest neighbors, logistic regression, native Bayes model, etc., may be used. In one nonlimiting example, the random forest model may be used. It is appreciated that random forest model may be an ensemble learning method for classification and regression to construct various decisions trees during the training phase of the model generation. Random forest may be used to rank important variables, e.g., moisture levels, acoustic speed of the response signal, acoustic amplitude of the response signal, etc., in a natural fashion. It is appreciated that in random forest an out of bag error for each data point is recorded and averaged during the fitting process and to measure the importance of various features during training the values are permuted among the training data and the error is again computed on the perturbed data set. The importance score for each feature is computed and averaged before and after the permutation over all trees and the score is normalized by the standard deviation of the differences. Features with large values for the score are ranked as more important in comparison to other features. Once the model is generated, it can be used during operation to correlated the measured speed and/or amplitude of the acoustic response signal to a known moisture level as indicated by the model.

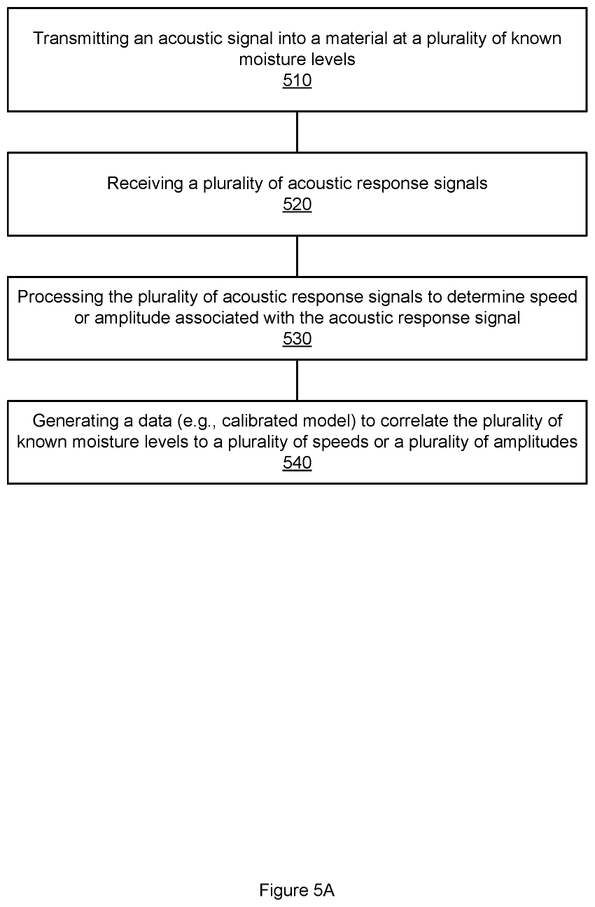

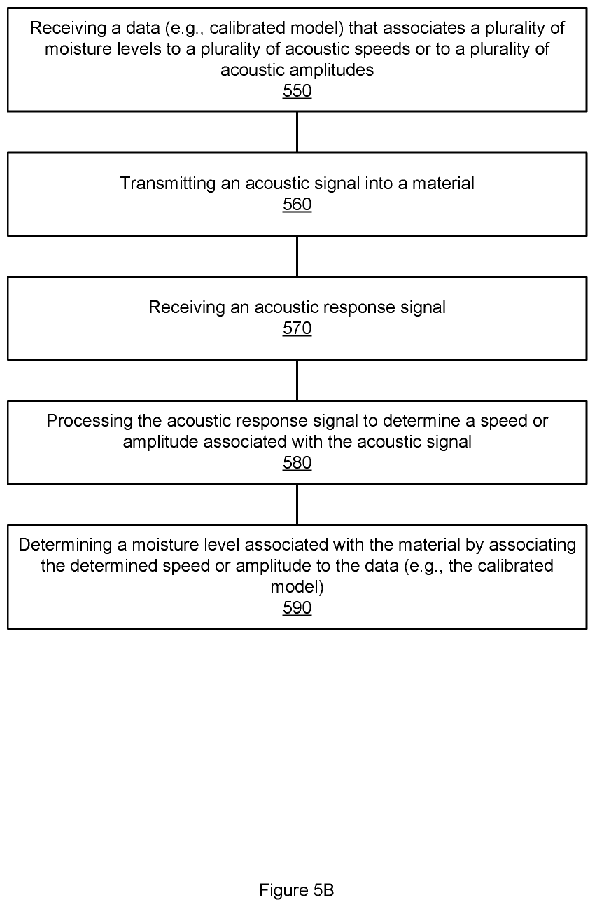

FIG. 5A shows a nonlimiting example of a flow diagram associated with generating a data (e.g., calibrated model) to be used in determining moisture content level in accordance with some embodiments. At step 510, an acoustic signal is transmitted into a material at a known moisture level. The acoustic signal changes into an acoustic response signal after it passes through the material. At step 520, an acoustic response signal is received. It is appreciated that steps 510 and 520 may be repeated for different moisture levels, thereby generating a plurality of acoustic response signals, one for each moisture level. At step 530, the acoustic response signals are processed to determine speed or amplitude associated with the acoustic response signal, i.e., speed or amplitude of the acoustic response signal at each moisture level. At step 540, a data (e.g., calibrated model) is generated that correlates the plurality of moisture levels to the plurality of speeds or the plurality of amplitudes. It is appreciated that in some embodiments, the plurality of moisture levels may be controlled using an air flow controller, as described above. As described above, the data may be generated based on one or more factors, e.g., a distance between an acoustic transmitter and an acoustic receiver, a packing density of the material, and the plurality of acoustic speeds or amplitudes at known moisture levels, as described above.

FIG. 5B shows a nonlimiting example of a flow diagram associated with determining a moisture level content based on the calibrated model in accordance with some embodiments. At step 550, the data generated in FIG. 5A is received where the data (e.g., a calibrated model) associates a plurality of moisture levels to a plurality of acoustic speeds or to a plurality of acoustic amplitudes. At step 560, an acoustic signal, e.g., a Tukey window sinusoidal burst signal, is transmitted into a material, e.g., corn stover. At step 570, an acoustic response signal is generated and received by an acoustic signal receiver. At step 580, the acoustic response signal is processed to determine a speed or amplitude associated with the acoustic signal. At step 590, a moisture level associated with the material is determined by associating the determined speed or the determined amplitude to the data (e.g., the calibrated model), as described above. It is appreciated that in some embodiments, the generated acoustic signal is amplified before transmitting. Moreover, in some embodiments, the acoustic response signal is amplified when received by the acoustic receiver. The method may further include transporting the material and positioning the material between an acoustic transmitter and an acoustic receiver.

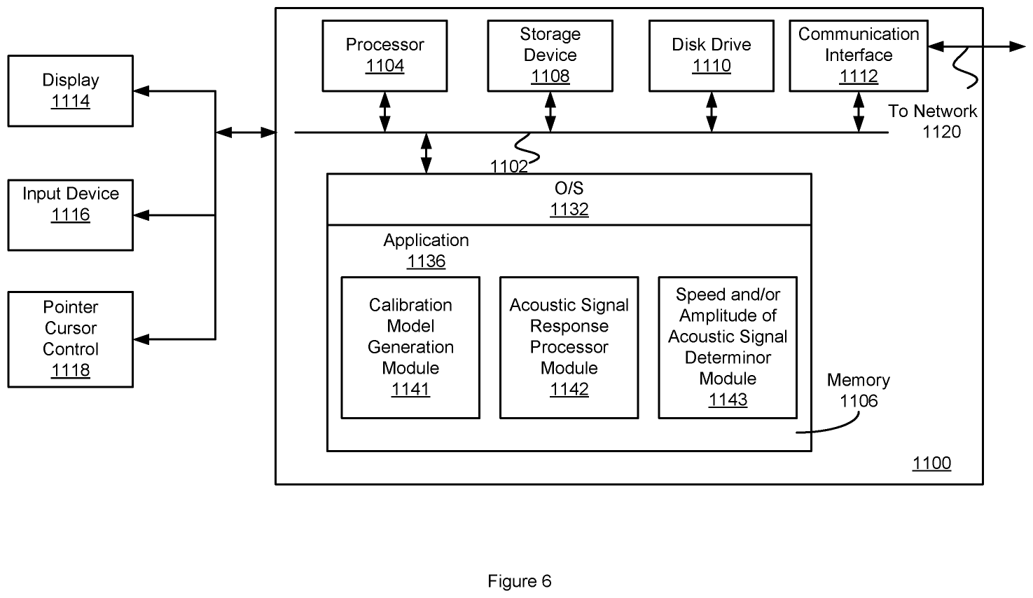

FIG. 6 shows a block diagram depicting an example of computer system suitable for measuring/processing moisture content in accordance with some embodiments. In some examples, computer system 1100 can be used to implement computer programs, applications, methods, processes, or other software to perform the above-described techniques and to realize the structures described herein. Computer system 1100 includes a bus 1102 or other communication mechanism for communicating information, which interconnects subsystems and devices, such as a processor 1104, a system memory (“memory”) 1106, a storage device 1108 (e.g., ROM), a disk drive 1110 (e.g., magnetic or optical), a communication interface 1112 (e.g., modem or Ethernet card), a display 1114 (e.g., CRT or LCD), an input device 1116 (e.g., keyboard), and a pointer cursor control 1118 (e.g., mouse or trackball). In one embodiment, pointer cursor control 1118 invokes one or more commands that, at least in part, modify the rules stored, for example in memory 1106, to define the electronic message preview process.

According to some examples, computer system 1100 performs specific operations in which processor 1104 executes one or more sequences of one or more instructions stored in system memory 1106. Such instructions can be read into system memory 1106 from another computer readable medium, such as static storage device 1108 or disk drive 1110. In some examples, hard-wired circuitry can be used in place of or in combination with software instructions for implementation. In the example shown, system memory 1106 includes modules of executable instructions for implementing an operating system (“OS”) 1132, an application 1136 (e.g., a host, server, web services-based, distributed (i.e., enterprise) application programming interface (“API”), program, procedure or others). Further, application 1136 includes a module of executable instructions associated with a calibration model generation module 1141 to generate a calibrated model that is used to determine the moisture content based on speed and/or amplitude of the acoustic signal, an acoustic signal response processor 1142 that is configured to determine the response to the acoustic signal generated, and a speed and/or amplitude of acoustic signal determinor module 1143 that is configured to perform processing such as Fast Fourier Transform and/or cross correlation to determine the speed and/or amplitude associated with a response to the acoustic signal that was generated, as described above.

The term “computer readable medium” refers, at least in one embodiment, to any medium that participates in providing instructions to processor 1104 for execution. Such a medium can take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 1100. According to some examples, two or more computer systems 1100 coupled by communication link 1120 (e.g., LAN, PSTN, or wireless network) can perform the sequence of instructions in coordination with one another. Computer system 1100 can transmit and receive messages, data, and instructions, including program code (i.e., application code) through communication link 1120 and communication interface 1112. Received program code can be executed by processor 1104 as it is received, and/or stored in disk drive 1110, or other non-volatile storage for later execution. In one embodiment, system 1100 is implemented as a hand-held device. But in other embodiments, system 1100 can be implemented as a personal computer (i.e., a desktop computer) or any other computing device. In at least one embodiment, any of the above-described delivery systems can be implemented as a single system 1100 or can implemented in a distributed architecture including multiple systems 1100.

In other examples, the systems, as described above can be implemented from a personal computer, a computing device, a mobile device, a mobile telephone, a facsimile device, a personal digital assistant (“PDA”) or other electronic device.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML, XHTML, HTTP, XMPP, Python, and others. These can be varied and are not limited to the examples or descriptions provided.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system comprising:
an acoustic transmitter configured to transmit an acoustic signal into a material with an unknown moisture level, wherein the acoustic signal associated with the material with the unknown moisture level changes into an acoustic response signal after passing through the material;
an acoustic receiver configured to receive the acoustic response signal associated with the material with the unknown moisture level;
a memory component configured to store data, wherein the data comprises a plurality of moisture levels associated with a plurality of acoustic speeds of a plurality of acoustic response signals; and
a processor coupled to the acoustic receiver and to the memory, wherein the processor is configured to determine a speed of the acoustic response signal associated with the material with the unknown moisture level, and further configured to determine an actual moisture level of the unknown moisture level of the material by associating the speed of the acoustic response signal associated with the material with the unknown moisture level to the data in the memory component.

2. The system as described in claim 1, further comprising an amplifier coupled to the acoustic transmitter, wherein the amplifier is configured to amplify the acoustic signal associated with the material with the unknown moisture level.

3. The system as described in claim 1, further comprising a preamplifier coupled to the acoustic receiver, wherein the preamplifier is configured to amplify the acoustic response signal.

4. The system as described in claim 1, wherein the data comprises a calibrated model.

5. The system as described in claim 4, wherein the calibrated model is generated based on a distance between the acoustic transmitter and the acoustic receiver, a packing density of the material, and the plurality of acoustic signal speeds through the material at known moisture levels.

6. The system as described in claim 1, wherein the acoustic transmitter faces the acoustic receiver.

7. The system as described in claim 1, wherein the acoustic signal is a Tukey window sinusoidal burst signal.

8. A system comprising:
an acoustic transmitter configured to transmit an acoustic signal into a material with an unknown moisture level, wherein the acoustic signal associated with the material with the unknown moisture level changes into an acoustic response signal after passing through the material;
an acoustic receiver configured to receive the acoustic response signal associated with the material with the unknown moisture level;
a memory component configured to store data, wherein the data comprises a plurality of moisture levels associated with a plurality of acoustic amplitudes of a plurality of acoustic response signals; and
a processor coupled to the acoustic receiver and to the memory, wherein the processor is configured to determine an amplitude of the acoustic response signal associated with the material with the unknown moisture level, and further configured to determine an actual moisture level of the unknown moisture level of the material by associating the amplitude of the acoustic response signal associated with the material with the unknown moisture level to the data in the memory component.

9. The system as described in claim 8, further comprising an amplifier coupled to the acoustic transmitter, wherein the amplifier is configured to amplify the acoustic signal.

10. The system as described in claim 8, further comprising a preamplifier coupled to the acoustic receiver, wherein the preamplifier is configured to amplify the acoustic response signal.

11. The system as described in claim 8, wherein the data comprises calibrated model.

12. The system as described in claim 11, wherein the calibrated model is generated based on a distance between the acoustic transmitter and the acoustic receiver, a packing density of the material, and the plurality of acoustic amplitudes through the material at known moisture levels.

13. The system as described in claim 10, wherein the acoustic transmitter faces the acoustic receiver.

14. The system as described in claim 10, wherein the acoustic signal is a Tukey window sinusoidal burst signal.

15. A method comprising:
transmitting an acoustic signal into a material with an unknown moisture level, wherein the acoustic signal associated with the material with the unknown moisture level changes into an acoustic response signal after passing through the material;
receiving the acoustic response signal associated with the material with the unknown moisture level;
processing the acoustic response signal to determine a speed of the acoustic response signal; and
determining a moisture level of the material by associating the speed of the acoustic response signal to a data, wherein the data comprises a plurality of moisture levels associated with a plurality of acoustic speeds of a plurality of acoustic response signals.

16. The method as described in claim 15, further comprising amplifying the acoustic signal associated with the material with the unknown moisture level.

17. The method as described in claim 15, further comprising amplifying the acoustic response signal.

18. The method as described in claim 15, wherein the data is a calibrated model that is generated based on a distance between an acoustic transmitter and an acoustic receiver, a packing density of the material, the plurality of acoustic signal speeds through the material at known moisture levels.

19. The method as described in claim 15, further comprising transporting the material and positioning the material between an acoustic transmitter and an acoustic receiver.

20. The method as described in claim 15, wherein the acoustic signal is a Tukey window sinusoidal burst signal.

21. A method comprising:
transmitting an acoustic signal into a material with an unknown moisture level, wherein the acoustic signal associated with the material with the unknown moisture level changes into an acoustic response signal after passing through the material;
receiving the acoustic response signal associated with the material with the unknown moisture level;
processing the acoustic response signal to determine an amplitude of the acoustic response signal; and
determining a moisture level of the material by associating the amplitude of the acoustic response signal to a data, wherein the data comprises a plurality of moisture levels associated with a plurality of acoustic amplitudes of a plurality of acoustic response signals.

22. The method as described in claim 21, further comprising amplifying the acoustic signal associated with the material with the unknown moisture level.

23. The method as described in claim 21, further comprising amplifying the acoustic response signal.

24. The method as described in claim 21, wherein the data is a calibrated model that is generated based on a distance between an acoustic transmitter and an acoustic receiver, a packing density of the material, the plurality of acoustic signal amplitudes through the material at known moisture levels.

25. The method as described in claim 21, further comprising transporting the material and positioning the material between an acoustic transmitter and an acoustic receiver.

26. The method as described in claim 21, wherein the acoustic signal is a Tukey window sinusoidal burst signal.

27. A method comprising:
transmitting a plurality of acoustic signals into a material at a plurality of known moisture levels, wherein an acoustic signal changes into an acoustic response signal after passing through the material;
processing a plurality of acoustic response signals resulting from the plurality of acoustic signals to determine a speed or amplitude associated with the plurality of acoustic response signals; and
generating a data to correlate the plurality of known moisture levels to a plurality of speeds or a plurality of amplitudes.

28. The method as described in claim 27, further comprising controlling the plurality of moisture levels using an air flow controller.
